(19) United States
(12) Patent Application Publication
(10) Pub. No.: US 2008/0107511 A1
(43) Pub. Date: May 8, 2008

(54) Pallet puller tool

(75) Inventor: James D. Oberg, Eagle Bend, MN (US)

Correspondence Address: NIKOLAI & MERSEREAU, P.A., 900 SECOND AVENUE SOUTH, SUITE 820, MINNEAPOLIS, MN, 55402, US

(73) Assignee: BAC Industries, Inc., Miltona, MN (US)

(21) Appl. No.: 11/591,961

(22) Filed: Nov. 2, 2006

(51) Int. Cl. B62B 1/06; B62B 1/26

(52) U.S. Cl. 414/445; 414/490; 254/131

(57) ABSTRACT

A tool for dragging wooden shipping pallets along the ground comprises a wheel-mounted base member that has an elongated handle attached to it. The base member supports a pair of jaw members that is pivotally joined to one another along with a pair of linkages pivotally joined at one end to the base member and at the other ends to the end portions of the jaw members. A tension spring is connected between the pivot points where the linkages join to the end portions of the jaw members to normally urge the jaws to be closed relative to one another. A cable or cord attaches at one end of the pivot joint between the two jaw members and extends along the length of the handle to a pull knob. Tension on the cable or cord acts against the force of the spring to open the jaw members.

### BACKGROUND OF THE INVENTION

I. Field of the Invention

This invention relates generally to material handling tools, and more particularly to a tool for grasping and dragging wooden shipping pallets along a floor surface.

II. Discussion of the Prior Art

In shipping and receiving departments of factories, warehouses and retail establishments, products are often contained on wooden pallets so that a forklift machine can readily pick up and transport the pallet and products from one point to another. Another well-known machine for manipulating pallets is the so-called “pallet-jack”. The pallet-jack machine rides on wheels and has a pair of tines or forks that are spaced apart by a distance dictated by the dimensions of the pallet to be carried. An elongated handle can be pumped up-and-down to hydraulically or otherwise elevate the forks and raise a pallet from the floor so that the pallet-jack can be easily pulled. The Fahnestock U.S. Pat. No. 1,115,796 is an example of this type of tool.

It is frequently necessary to reposition empty pallets in warehouses or factories, say, in moving them from a receiving department to the production floor or merely moving them to and from an empty pallet storage area in the building. While a forklift or pallet-jack could be used, such machines are relatively costly and should be used for moving loaded pallets or stacks thereof rather than moving an empty pallet one at a time.

Thus, a need exists for a relatively low cost tool that can be used to pull individual, unloaded wooden pallets from one point to another in an industrial or retail setting. The tool should be of a type that makes it unnecessary for a laborer to manually pick up and carry a wooden pallet that may typically weigh 50 lbs. or more and is somewhat unwieldy in shape. The present invention is just such a tool.

### SUMMARY OF THE INVENTION

In accordance with the present invention, there is provided a tool for grasping and pulling articles, such as wooden pallets. The tool includes a base member that is supported from the ground by a pair of wheels. An elongated handle having first and second ends, the first end being connected to the base plate and a second end that connects to a grip member that extends transversely to the longitudinal axis of the handle. Coupled to the base member is a pair of jaw members, each having first and second end portions. The pair of jaw members is pivotally joined to one another at a location that is offset from the first and second end portions. More particularly, the pair of jaw members is coupled to the base member through first and second linkages that are pivotally coupled at a first end to the base member. The first linkage is pivotally coupled at its second end to the second end portion of one of the pair of jaw members. The second linkage is pivotally coupled at its second end to the second end portion of the other of the pair of jaw members. A tension spring extends between the second end portions of the pair of jaw members to urge the first end portions of the two jaw members toward one another. An elongated, flexible member, such as a cable, cord or wire, extends along the length of the handle from the grip member to the location offset from the first and second ends where the jaw members are pivotally joined to one another. A tension force applied to the elongated flexible member acts to stretch the spring and causes the first end portions of the jaw members to separate relative to one another. The first end portions of the jaw members can then be placed about a main stringer of the pallet to be moved and when the tension on the elongated flexible member is released, the spring will urge the first end portions of the jaw members firmly against the wooden stringer so that now when the handle is pulled, the wheeled tool will drag the pallet with it. The linkages are arranged such that the pulling force applied to the handle causes the jaws to more firmly grip the pallet stringer.

### DESCRIPTION OF THE DRAWINGS

The foregoing features, objects and advantages of the invention will become apparent to those skilled in the art from the following details description of a preferred embodiment especially when considered in conjunction with the accompanying drawings in which:

FIG. 1 is a perspective view of the pallet-puller tool constructed in accordance with the present invention;

FIG. 2 is an enlarged partial view of the tool of FIG. 1;

FIG. 3 is a detailed view of a first end portion of one of the jaws seen in FIG. 2; and

FIG. 4 is a cross-sectional view taken along the line 4-4 in FIG. 1.

### DESCRIPTION OF THE PREFERRED EMBODIMENT

Certain terminology will be used in the following description for convenience in reference only and will not be limiting. The words “upwardly”, “downwardly”, “rightwardly” and “leftwardly” will refer to directions in the drawings to which reference is made. The words “inwardly” and “outwardly” will refer to directions toward and away from, respectively, the geometric center of the device and associated parts thereof. Said terminology will include the words above specifically mentioned, derivatives thereof and words of similar import.

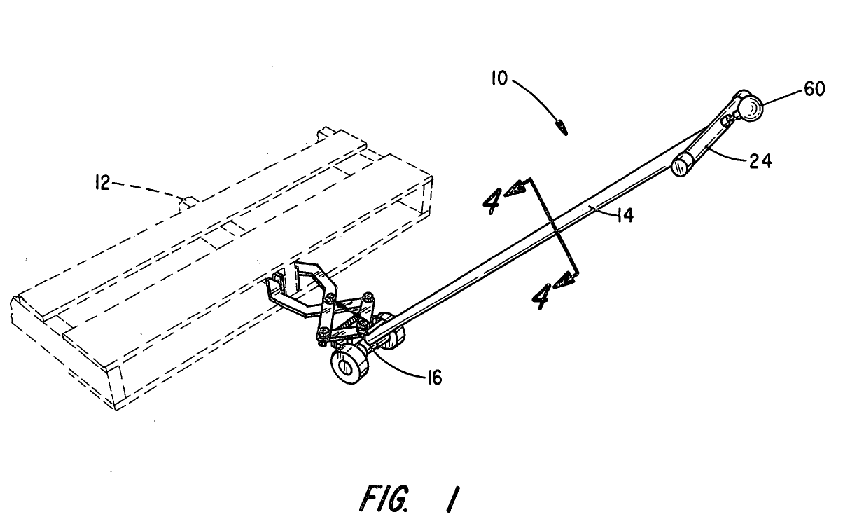

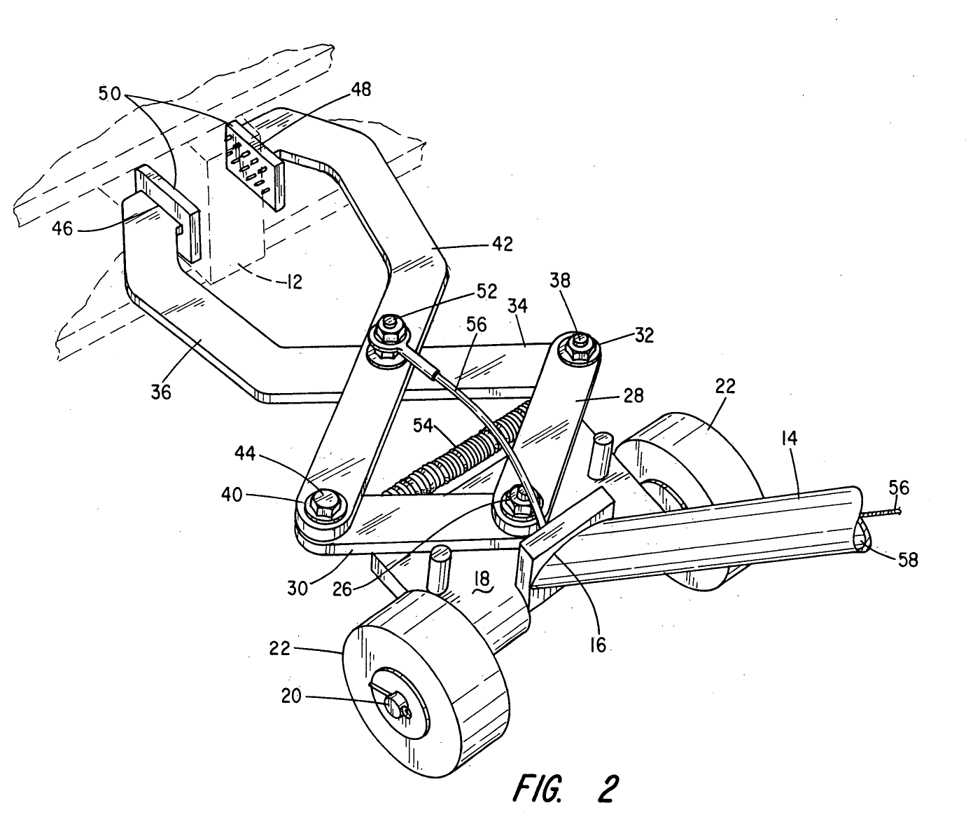

Referring to FIG. 1, there is indicated generally by numeral 10 a pallet-puller tool constructed in accordance with the present invention. It is shown as being positioned about a center stringer 12 of a standard wooden pallet that is shown in ghost-line. The tool itself includes an elongated handle 14 that is preferably tubular that attaches at a first end 16 to a base plate 18 that is best seen in the view of FIG. 2. Projecting laterally outward from the side edges of the base plate are cylindrical stub axles 20 on which wheels 22, preferably made from a hard rubber or a suitable plastic, are rotatably mounted. Affixed to the upper end of the handle 14 is a grip member 24 that extends transversely to the longitudinal axis of the handle 14. Pivotally attached to the base member 18 by a shoulder bolt or other suitable fastener 26 are first ends of first and second linkages 28 and 30. The second end 32 of the linkage 28 pivotally couples to a second end 34 of a jaw member 36 by a suitable pin or shoulder bolt. In a similar fashion, a second end of the linkage 30 is pivotally connected to a second end portion 40 of a second jaw member 42 by a suitable pin or shoulder bolt 44.

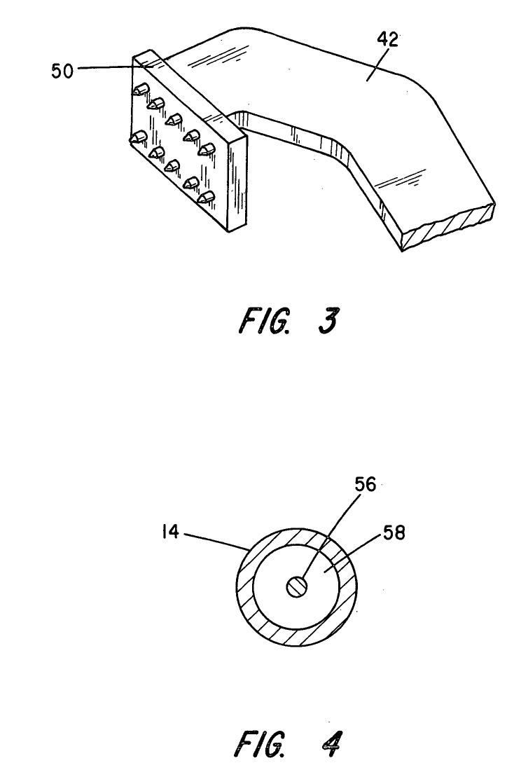

The first ends of the jaw members are identified by numerals 46 and 48 and have steel pads 50 welded thereto. These pads each carry an array of sharpened spikes projecting from an outer surface thereof as is more clearly seen in the partial view of FIG. 3. These spikes are designed to penetrate into and grip the wooden stringer 12 as will be more fully explained.

The two jaw members 36 and 42 are pivotally coupled to one another by a pin or shoulder bolt 52 at a location that is offset from the opposed ends of the jaw members. The offset is such that the length of the jaw members between the location of the pivots 38 and 52 and between the pivots 44 and 52 is equal to the distance between the pivots 26 and 38 and 26 and 44 so as to create a four-bar linkage parallelogram.

With continued reference to FIG. 2, it can be seen that a tension spring 54 is coupled between the pivot fasteners 38 and 44 such that the first ends of the jaws 46 and 48 are urged together, i.e., the jaws close. An elongated flexible member 56 that may be a cable, a cord or a wire is attached at one end to the pivot fastener 52 and it extends through the lumen 58 of the tubular handle as shown in FIG. 4 and attaches at its opposite end to a pull knob 60 located adjacent the grip member 24 on the handle 14. By grasping and pulling on the knob 60, the resulting force on the pivot fastener 52 will cause the pads 50 on the jaw members 36 and 42 to move away from one another as the spring 54 is further tensioned.

### Operation

Having explained the constructional features of the pallet-puller tool of the present invention, consideration will next be given to its mode of operation.

In use, an operator will approach a pallet sitting on the floor while pulling on the knob 60 to force the jaw pads 50 to an open condition relative to one another so that they can be fitted on either side of the stringer 12 of a pallet to be manipulated. The tension on the cable 56 will then be released, allowing the spring 54 to cause the ends of the jaws to close relative to one another such that the spikes on the pads 50 press somewhat into the wood of the stringer 12. Now, when the operator pulls on the handle grip member 24 to pull the pallet, the spikes on the pad members 50 dig in even further. Thus, the pallet is both gripped and towed to a desired destination. At this point, tension is again applied to the cable 56, via the pull knob 60, to again force the jaw pads 50 apart relative to one another, releasing the pallet.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A tool for grasping and pulling articles comprising:
(a) a base member supported from the ground by a pair of wheels;
(b) an elongated handle having first and second ends, the first end connected to the base plate and the second end connected to a grip member that extends transversely to the handle;
(c) a pair of jaw members having first and second end portions and pivotally joined to one another at a location offset from the first and second end portions;
(d) first and second linkages pivotally coupled at a first end to the base member, the first linkage being pivotally coupled at a second end to the second end portion of one of the pair of jaw members and the second linkage being pivotally coupled at a second end to the second end portion of the other of the pair of jaw members; and
(e) a tension spring extending between the second end portions of the pair of jaw members to urge the first end portions of the pair of jaw members toward one another and
(f) an elongated, flexible member extending along the length of the handle from the grip member to the location offset from the first and second ends where the jaw members are pivotally joined to one another whereby a tension force applied to the elongated flexible member tensions the spring and causes the first end portions of the jaw members to separate relative to one another.

2. The tool as in claim 1 and further including a pull knob affixed to the elongated, flexible member.

3. The tool as in claim 2 wherein the elongated, flexible member is a steel cable.

4. The tool as in claim 2 wherein the elongated flexible member is a cord.

5. The tool as in claim 2 wherein the elongated, flexible member is a wire.

6. The tool as in claim 1 and further including a plate affixed to the first end portions of the pair of jaw members.

7. The tool as in claim 6 and further including an array of spikes projecting from the plates.

8. The tool as in claim 1 wherein the articles comprise wooden pallets.

9. The tool as in claim 1 wherein the first and second linkages and the portions of the pair of jaw members between their second ends and the location where they are pivotally joined to one another form a four-bar parallelogram linkage assembly.

10. The tool as in claim 9 wherein the four-bar parallelogram linkage assembly is cantilevered from the base member.
